(19) United States
(12) Patent Application Publication
(10) Pub. No.: US 2026/0067986 A1
(43) Pub. Date: Mar. 5, 2026

(54) SYSTEM AND METHOD OF JOINING A MULTI-AP COORDINATED GROUP

(71) Applicant: Samsung Electronics Co., Ltd., Suwon-si (KR)

(72) Inventors: Abhishek CHATURVEDI, Bengaluru (IN); Karthik Srinivasa GOPALAN, Bengaluru (IN); Anand JEE, Bengaluru (IN); Rishabh ROY, Bengaluru (IN)

(21) Appl. No.: 19/332,810

(22) Filed: Sep. 18, 2025

Related U.S. Application Data
(63) Continuation of application No. PCT/KR2025/013159, filed on Aug. 28, 2025.

(30) Foreign Application Priority Data
Sep. 4, 2024 (IN) 202441067012
Jul. 29, 2025 (IN) 202441067012

(51) Int. Cl. H04W 76/40; H04W 88/08

(52) U.S. Cl. CPC H04W 76/40; H04W 88/08

(57) ABSTRACT

The present disclosure relates to a method and an apparatus for managing a multi-access point (AP) coordinated group by at least one AP. The method comprises: broadcasting coordination information comprising a group identifier and guard window time information; receiving a join request from an external AP requesting to join the multi-AP coordinated group; determining whether the external AP is permitted to join the multi-AP coordinated group based on the guard window time information; and transmitting a response to the external AP based on the determination, wherein the response may indicate whether the join request is accepted or rejected.

### CROSS-REFERENCE TO RELATED APPLICATIONS

This application is a continuation of International Application No. PCT/KR2025/013159 designating the United States, filed on Aug. 28, 2025, in the Korean Intellectual Property Receiving Office and claiming priority to Indian Provisional Patent Application No. 202441067012, filed on Sep. 4, 2024, and Indian Complete Patent Application No. 202441067012, filed on Jul. 29, 2025, the disclosures of each of which are incorporated by reference herein in their entireties.

### BACKGROUND

### Field

The disclosure generally relates to the field of wireless communication. For example, the present disclosure relates to a method and system for managing coordinated groups of access points (APs) in wireless local area networks (WLANs).

### Description of Related Art

As wireless communication standards evolve to meet the growing demands of ultra-high reliability (UHR), high throughput, and low-latency applications, the IEEE 802.11 task group has extensively investigated architectural enhancements for Wi-Fi 8, with a particular emphasis on multi-access point (multi-AP) coordination. The core idea is to enable an access point (AP) to discover neighboring APs, engage in bilateral or multilateral exchanges of control information, and establish coordination protocols. This facilitates the formation of coordinated AP groups designed to reduce co-channel interference and promote efficient spectrum utilization.

These coordinated groups can dynamically optimize channel access strategies, leading to enhanced spatial reuse, better medium utilization, and improved user experience across diverse deployment scenarios. The various coordination schemes under consideration include Coordinated Access Points (Co-AP), Coordinated Time Division Multiple Access (Co-TDMA), Coordinated Restricted Target Wake Time (Co-RTWT), Coordinated Beamforming (Co-BF), Coordinated Spatial Reuse (Co-SR), and Coordinated Joint Transmissions (Co-JT), among others.

Two multi-AP architectures have emerged: a centralized model where APs elect a group owner or coordinator to manage synchronization and control flows, and a distributed model wherein APs form coordination pairs and maintain peer-wise coordination without centralized control. The centralized approach is typically more suited to enterprise-grade deployments, whereas the distributed model fits residential and unmanaged environments better.

An important use case is seamless client roaming across APs in the same mobility domain. In such scenarios, ensuring near-lossless data handover and minimal association latency requires architectural features such as enhanced context transfer, reduction of signalling steps, pre-authentication, and proactive configuration of multiple candidate APs.

Proposed mechanisms may involve signalling through a Common Control Entity or over-the-Distribution System (DS), aiming to pre-negotiate handoff conditions and reduce real-time decision-making overhead.

The description set forth in the background section should not be assumed to be prior art merely because it is set forth in the background section. The background section may describe aspects or embodiments of the present disclosure.

### SUMMARY

According to an example embodiment, a method for managing a multi-access point (AP) coordinated group by at least one AP is disclosed. The method comprises: broadcasting coordination information comprising a group identifier and guard window time information; receiving a join request from an external AP requesting to join the multi-AP coordinated group and determining whether the external AP is permitted to join the multi-AP coordinated group based on the guard window time information; and transmitting a response to the external AP based on the determination, wherein the response indicates whether the join request is accepted or rejected.

According to an example embodiment, an apparatus for managing a multi-AP coordinated group is disclosed. The apparatus comprises: a memory and at least one processor, comprising processing circuitry, communicatively coupled with the memory, wherein at least one processor, individually and/or collectively, is configured to cause the apparatus to: broadcast coordination information comprising a group identifier and guard window time information; receive a join request from an external AP requesting to join the multi-AP coordinated group and determine whether the external AP is permitted to join the multi-AP coordinated group based on the guard window time information; and transmit a response to the external AP based on the determination, wherein the response indicates whether the join request is accepted or rejected.

### BRIEF DESCRIPTION OF THE DRAWINGS

The same numbers are used throughout the figures to reference like features and components. Further, the above and other aspects, features and advantages of certain embodiments of the present disclosure will be more apparent from the following detailed description, taken in conjunction with the accompanying drawings.

FIG. 1 is a diagram illustrating an example environment for managing a multi-AP coordinated group, according to various embodiments.

FIG. 2A is a diagram illustrating an example centralized multi-AP grouping architecture, according to various embodiments.

FIG. 2B is a diagram illustrating an example distributed multi-AP grouping architecture, according to various embodiments.

FIG. 3 is a flow diagram illustrating a unified framework for multi-AP coordination, according to various embodiments.

FIG. 4 is a signal flow diagram illustrating the final phase of a coordination group formation process in a multi-AP environment, according to various embodiments.

FIG. 5 is a diagram illustrating an example data structure for the coordination setup complete message in a multi-AP coordinated (MAPC) group, according to various embodiments.

FIG. 6 is a diagram illustrating an Ultra-High Reliability (UHR) Beacon frame structure incorporating MAPC group common information for supported coordination features, according to various embodiments.

FIG. 7 illustrates a flow diagram illustrating an example broadcast sequence of the Guard Window time information (GW_time_info) by participating APs within a MAPC group, according to various embodiments.

FIG. 8A is a signal flow diagram illustrating an example of a new AP directly communicating with a group owner AP to join an existing multi-AP coordinated (MAPC) group, according to various embodiments.

FIG. 8B is a signal flow diagram illustrating an example of a new AP initiating communication with one of the participating APs to join an existing multi-AP coordinated (MAPC) group, according to various embodiments.

FIG. 9A is a signal flow diagram illustrating an example of managing join requests from an external access point (AP) under a short-term guard window (GW) policy according to various embodiments.

FIG. 9B is a signal flow diagram illustrating an example behaviour of a coordinated MAPC group under a long-term guard window (GW) policy, according to various embodiments.

FIG. 9C is a signal flow diagram illustrating example behaviour of a coordinated MAPC group where the APs may be operating with a mix of short-term and long-term coordination schemes, according to various embodiments.

FIG. 10 is a signal flow diagram illustrating example enhanced guard window (GW) policy validation based on a dynamic offset mechanism, according to various embodiments.

FIG. 11 is a block diagram illustrating an example configuration of an apparatus for managing a multi-access point (AP) coordinated group, according to various embodiments.

FIG. 12 is a flowchart illustrating an example method for managing a multi-access point (AP) coordinated group, according to various embodiments.

It may be appreciated by those skilled in the art that the diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present disclosure, the word “exemplary” is used herein to refer to “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, example embodiments thereof have been shown by way of example in the drawings and will be described in detail below. It can be understood, however, that it is not intended to limit the disclosure to the particular forms disclosed, but on the contrary, the disclosure is intended to cover a plurality of modifications, equivalents, and alternative falling within the spirit and the scope of the disclosure.

The terms “comprise”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of various example embodiments of the disclosure, reference is made to the accompanying drawings that form a part thereof, and in which are shown by way of illustration specific embodiments in which the disclosure may be practiced. It is to be understood that various embodiments may be utilized and that changes may be made without departing from the scope of the present disclosure. The following description is, therefore, not to be taken in a limiting sense.

Embodiments of the present disclosure relate to a method and system for enabling a new access point (AP) to join an existing multi-AP coordinated group during a post-coordination phase in a wireless local area network (WLAN). The methods and systems facilitate the discovery of coordination information broadcast by the group and allow the joining AP to negotiate compatibility and synchronize its coordination behavior with that of the group. The methods and systems of the present disclosure also support selective advertisement and negotiation of feature-specific coordination capabilities between the joining AP and the group owner. Further, the methods and systems of the present disclosure enable seamless integration of new APs without requiring reformation of the group or disruption of ongoing multi-AP operations. This enhances scalability, ensures robust synchronization, and maintains backward compatibility with legacy APs. The resulting advantages include reduced signaling overhead, consistent group behavior, and efficient dynamic expansion of coordinated AP coverage.

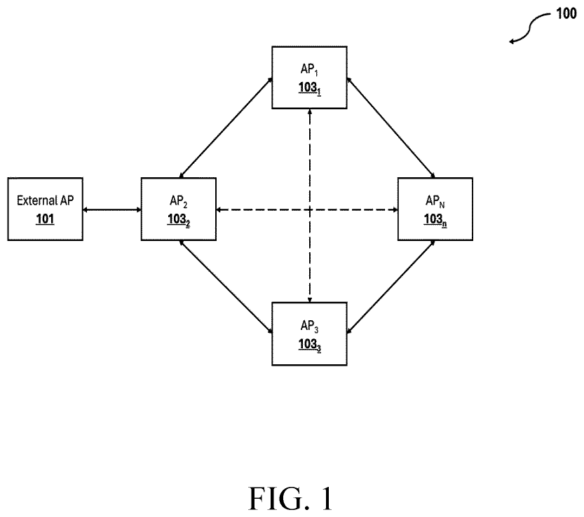

FIG. 1 is a diagram illustrating an example environment 100 for managing a multi-AP coordinated group in a wireless local area network (WLAN), according to various embodiments. The environment 100 may include an external access point (external AP) 101 and a set of coordinated access points (APs) AP₁ 103₁ to APₙ 103ₙ.

The APs 103₁ to 103ₙ may form part of a coordinated multi-AP group that may have completed a primary negotiation phase for multi-AP coordination. Each AP within the group may be configured to participate in feature-specific coordination schemes including, but not limited to, coordinated beamforming, spatial reuse, and restricted target wake time (R-TWT) scheduling.

The external AP 101 may represent an access point initially outside the coordinated group. In various embodiments, the external AP 101 may be configured to discover one or more APs in the coordinated multi-AP group and receive broadcasted coordination information therefrom. For instance, the external AP 101 may be configured to receive such information from AP₂ 103₂ or any other member of the coordinated group.

The APs 103₁ to 103ₙ may each be configured to transmit coordination-related information via broadcast frames or multi-AP coordination messages. In various embodiments, at least one of the APs (e.g., AP₂ 103₂) may function as a group owner or lead AP or a coordinator AP and may be configured to advertise group-wide coordination parameters to facilitate integration of new APs (such as the external AP 101).

Upon successful reception and interpretation of the coordination parameters, the external AP 101 may be dynamically integrated into the coordinated group and may synchronize the external AP's 101 behavior with one or more coordination schemes active in the multi-AP environment 100. This integration may enable the coordinated group to continue operation with the newly added external AP 101 without requiring a full reformation of the existing group. The method by which the external AP 101 joins the coordinated group is described in further detail in the various example embodiments below.

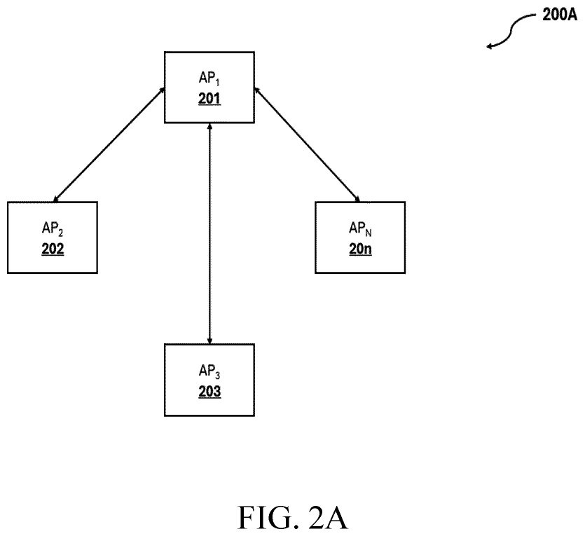

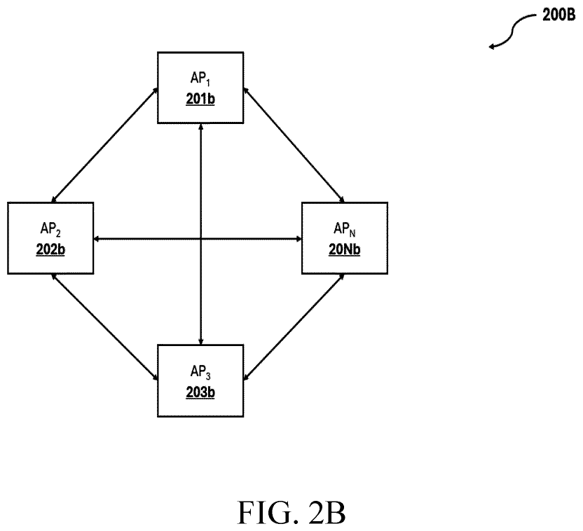

FIG. 2A is a diagram illustrating an example centralized multi-AP grouping architecture 200A, according to various embodiments.

As shown in FIG. 2A, the centralized multi-AP grouping architecture 200A may include a plurality of access points (APs), including a designated group owner AP₁ 201, and participating APs such as AP₂ 202, AP₃ 203, and APₙ 20n. In an embodiment, the AP₁ 201 may be selected as the group owner based on its advertised coordination capabilities as broadcast in management frames, for example, beacon frames. The AP₁ 201 may be configured to manage and organize the coordination within the group of participating APs.

The participating APs 202, 203, 20n may first discover one another and AP₁ 201 based on the coordination capabilities of each AP and engage in signalling procedures for negotiation and agreement related to the coordination scheme(s). Upon formation of the coordinated group, AP₁ 201 may be configured to disseminate coordination information to all member APs, thereby allowing every AP in the group to be aware of the coordination activity between every other AP. As a result, the coordinated group may operate in a centralized manner, with AP₁ 201 facilitating centralized visibility and control across the multi-AP environment.

FIG. 2B is a diagram illustrating an example distributed multi-AP grouping architecture 200B, according to various embodiments.

As shown in FIG. 2B, the distributed multi-AP grouping architecture 200B may include a plurality of access points (APs), such as AP₁, to APₙ, 201b to 20nb. In an embodiment, one or more of the APs 201b to 20nb may advertise their coordination capabilities and may be configured to discover neighboring APs that are also capable of multi-AP (MAP) coordination.

Upon discovery, an initiating AP may request to establish a coordination pair with a neighboring AP. Following successful setup, each AP of the coordination pair may include the other AP in its own MAP list. The MAP list of each AP may include one or more such coordination peer APs. The set of APs included in these lists collectively forms a distributed MAP group.

In such a distributed grouping arrangement, each AP may only be aware of the coordination information associated with the APs present in own MAP list and may not have visibility into the coordination status of other APs that are part of the MAP lists of peer APs. This decentralized awareness allows for a more flexible grouping structure suitable for non-enterprise or residential AP deployments, where centralized control may not be feasible or necessary.

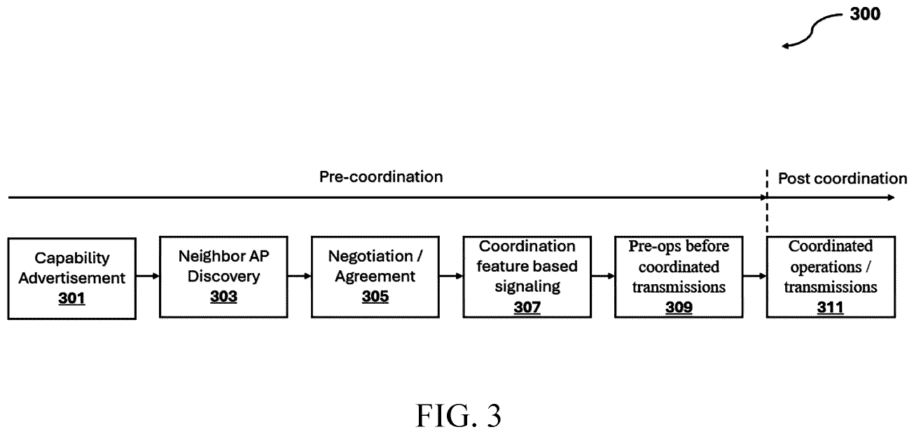

FIG. 3 is a flow diagram 300 illustrating an example unified framework for multi-AP coordination, according to various embodiments.

As shown in FIG. 3, the framework may represent a sequence of procedural stages applicable to various types of multi-AP grouping architectures currently under discussion in IEEE 802.11 task group contributions. The framework may be divided into two major phases: a pre-coordination phase and a post-coordination phase.

The pre-coordination phase may include a series of steps initiated by participating access points (APs). At 301, APs may advertise respective coordination capabilities through management frames or other broadcast mechanisms. At 303, the APs may discover neighboring APs based on the received capability advertisements. S 305 may involve negotiation and agreement procedures between the identified APs for the purpose of establishing coordination terms and affiliation.

At 307, the APs may engage in coordination feature-specific signalling. The feature-specific signalling may be optionally implemented and may be individually addressed to target APs, depending on the type of coordination scheme being adopted. At 309, the APs may execute pre-operations necessary before initiating actual coordinated transmissions. These pre-operations may include tasks such as synchronization, time/frequency alignment, or resource scheduling.

The post-coordination phase, represented by 311, may encompass the period during which actual coordinated operations and transmissions take place. This post-coordination phase may continue until the coordination session is terminated or re-negotiated.

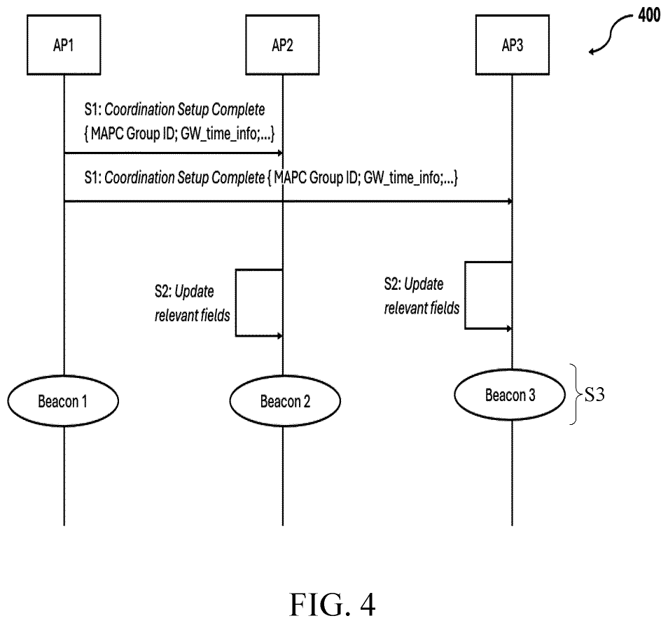

FIG. 4 is a signal flow diagram 400 illustrating a final phase of a coordination group formation process in a multi-AP environment, according to various embodiments. As shown in FIG. 4, the three access points (APs), namely AP1, AP2, and AP3, may be configured to participate in a multi-AP coordinated group. In an example scenario, AP1 may act as the group owner or coordinator AP of the multi-AP coordination (MAPC) group.

At S1, once the coordination setup is completed, AP1 may transmit a Coordination Setup Complete message to AP2 and AP3. This message may include a set of group-level parameters, such as a MAPC Group ID and GW_time_info, etc. These group-level parameters may be used by the receiving APs to align with the coordination context of the group.

At S2, each of AP1, AP2, and AP3 may update relevant internal parameters based on the received coordination setup information. This may include updating fields in their respective broadcast management frames, such as Beacon frames. These updated fields may reflect the group-level coordination context including, for example, the MAPC Group ID and time synchronization information.

At S3, each AP may begin broadcasting its updated Beacon frame-represented as Beacon 1, Beacon 2, and Beacon 3, respectively-based on the updated coordination parameters. The broadcast content may be dynamically adjusted depending on the type and format of the GW_time_info parameter and other group-related metadata. This ensures that each participating AP is aligned with the group's coordinated operations and can advertise its role accordingly.

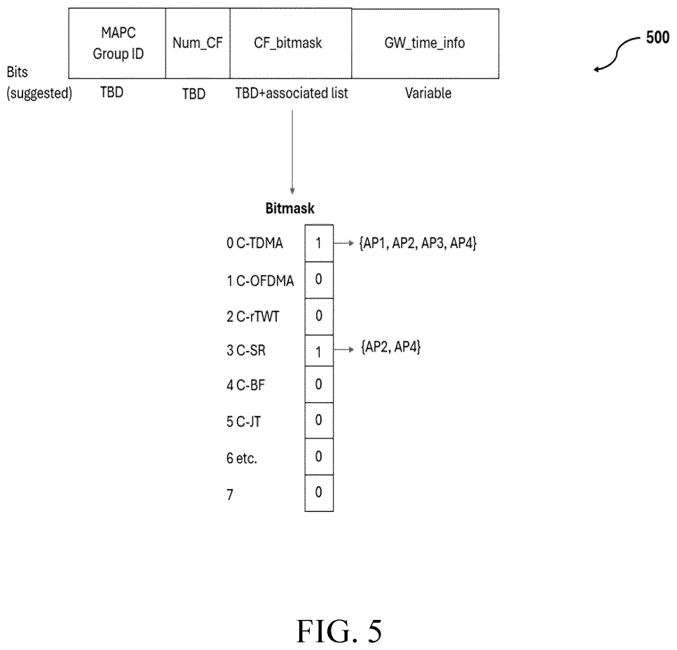

FIG. 5 is a diagram illustrating an example data structure 500 for the coordination setup complete message in a multi-AP coordinated (MAPC) group, according to various embodiments. The data structure may be used by the group owner or coordinating AP to broadcast group-level coordination parameters to all participating APs.

As shown in FIG. 5, the structure may include a field for a MAPC Group ID, which may uniquely identify the coordination group. The MAPC Group ID may be common across all APs participating in the group. In scenarios where an AP is simultaneously part of multiple groups supporting different coordination features, care may be taken to ensure that each group is assigned a distinct MAPC Group ID. To enable this, APs may share their currently associated MAPC Group IDs with a newly designated group owner during group formation to avoid conflicts.

The structure may also include a Num_CF field, which may denote the number of coordination features present in the group. This value may either be zero or correspond to the number of active bits set in a coordination feature bitmask (CF_bitmask). The CF_bitmask may comprise, for example, 8 bits, with each bit representing a specific coordination feature. For instance, bit 0 may represent Co-TDMA, bit 1 may represent C-OFDMA, bit 2 may represent Co-RTWT, bit 3 may represent Co-SR, and so forth.

For each coordination feature enabled in the group (e.g., a bit set to 1), an associated list of AP identifiers may be maintained, indicating which APs are participating in that particular coordination feature. For example, in the illustrated example: bit 0=1 may indicate Co-TDMA coordination, with associated APs {AP1, AP2, AP3, AP4}, and bit 3=1 may indicate Co-SR coordination, with associated APs {AP2, AP4}. This configuration may allow each AP in the MAPC group to be informed not only of the features in use, but also of the specific APs involved in each feature, thereby supporting a centralized coordination model.

The structure may include a GW_time_info field, which may provide Guard Window timing information relevant to the coordination features. The structure and interpretation of GW_time_info may vary based on the value of Num_CF. In an example embodiment, in case 1, if Num_CF=0, then the CF_bitmask is not referenced, and a single GW_time_info value may be used by all APs, regardless of feature-specific participation. In case 2, if Num_CF=2 and, for instance, bit 0 (Co-TDMA) and bit 3 (Co-SR) are enabled, then GW_time_info may contain two ordered entries, one for each active feature: {GW_time_info[0], GW_time_info[1]} where GW_time_info[0] corresponds to Co-TDMA, and GW_time_info[1] corresponds to Co-SR.

The various types and corresponding interpretations of the GW_time_info parameter, based on different combinations of Num_CF and CF_bitmask configurations, are summarized in Table 1 below:

TABLE 1

| Type | Num_CF | GW_time_info | Details |
|---|---|---|---|
| I | Zero | Non-zero | As per type I implementation, the participating APs |
| | | (single value) | shall not broadcast the support for the coordination |
| | | | features until the end of the GW_time_info value. |
| II | Zero | Non-zero | As per type II implementation, the participating APs |
| | | (single value) | shall include Guard Window ending time in its BSS |
| | | | broadcasts along with support for (corresponding AP's) |
| | | | coordination features in their management frames. |
| III | Non-zero | Non-zero | As per type III implementation, the participating APs |
| | | (0 to (Num_CF − 1) | shall broadcast the Guard Window ending time per |
| | | number of | coordination feature (for that corresponding AP e.g. Co- |
| | | values) | TDMA, Co-RTWT, Co-SR, Co-BF etc.) in their |
| | | | management frames. |

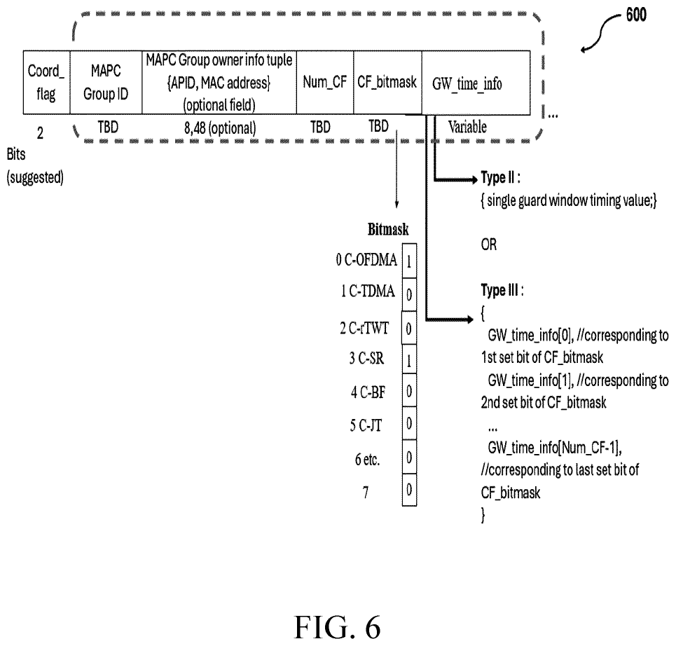

FIG. 6 is a diagram illustrating an example Ultra-High Reliability (UHR) Beacon frame structure 600 incorporating MAPC group common information for supported coordination features, according to various embodiments. After receiving the Coordination Setup Complete message from the group owner or coordinating AP, each participating AP may update its broadcast management frame—such as the Beacon frame—by embedding the group-level coordination information.

As per the IEEE 802.11-2020 specification, section 9.3.3.2, the disclosed implementation may introduce a dedicated section following item order 75 in the Beacon frame to carry MAPC-specific parameters. The updated UHR Beacon frame may include the following fields:

A 2-bit coordination flag (Coord_flag), which may indicate the AP's coordination state:
0: the AP is not part of any coordination group;
1: the AP is part of a coordination group identified by MAPC Group ID and is broadcasting a single GW_time_info value;
2: the AP is part of a coordination group identified by MAPC Group ID and is broadcasting feature-specific GW_time_info values.

A field for the MAPC Group ID, which may uniquely identify the coordination group to which the AP belongs. An optional variable-length field (e.g., 8 to 48 bits) that may include identifying information of the MAPC group owner, such as its APID or MAC address. A Num_CF field (e.g., at least 3 bits) representing the number of coordination features supported by the given AP. A fixed-size (e.g., 8 bits) coordination feature bitmask (CF_bitmask) identifying which features the AP supports (e.g., bit 0=Co-TDMA, bit 1=C-OFDMA, etc.). A GW_time_info field, which may either contain a single group-level guard window value or a list of feature-specific guard window values mapped according to the AP's CF_bitmask and Num_CF values.

These enhancements to the beacon frame may enable efficient broadcasting of coordination context by each AP, ensuring that other devices within range may become aware of the AP's group membership, supported coordination features, and associated timing information.

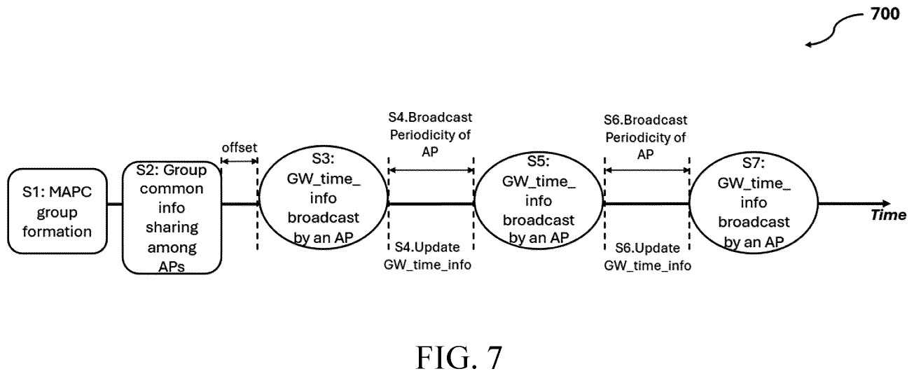

FIG. 7 is a flow diagram 700 illustrating an example broadcast sequence of the Guard Window time information (GW_time_info) by participating APs within a MAPC group, according to various embodiments.

At S1, a MAPC group may be formed with one AP designated as the group owner or coordinator. At S2, the group common information—including the initial GW_time_info—may be shared among the APs by the group owner. At S3, an AP may begin broadcasting the received GW_time_info starting from a defined offset position.

At S4, the AP may wait for a time duration corresponding to its configured broadcast periodicity, and before the next transmission, it may update the GW_time_info accordingly. At S5, the updated GW_time_info may be broadcasted again by the AP. At S6, the AP may once again wait for the same broadcast periodicity and updates the GW_time_info using the relation:

GW_time_info=GW_time_info−broadcast periodicity of the AP.

At S7, the AP may continue this cycle of updating and broadcasting GW_time_info until the timer value expires.

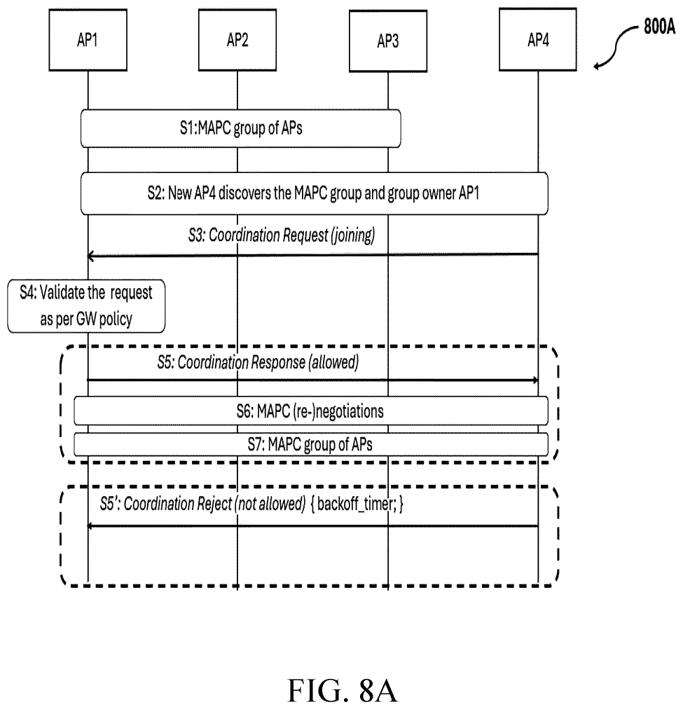

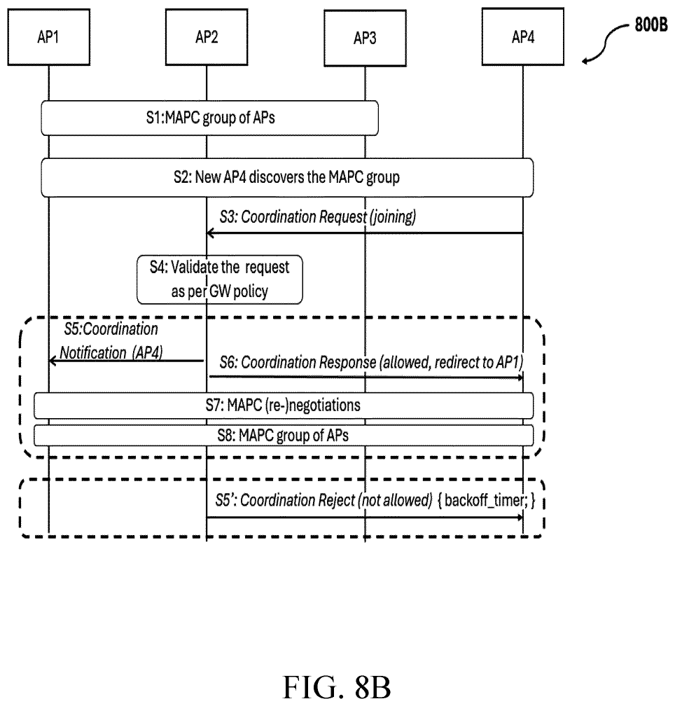

FIG. 8A is a signal flow diagram 800A illustrating an example of a new AP directly communicating with a group owner AP to join an existing multi-AP coordinated (MAPC) group, according to various embodiments.

As shown in FIG. 8A, at S1, a MAPC group comprising AP1, AP2, and AP3 may be established, with AP1 acting as the group owner or coordinating AP. Each of these participating APs may periodically broadcast their respective Beacon or management frames, optionally including the group owner's information (such as APID or MAC address).

At S2, a new external AP (AP4) may detect the presence of the MAPC group by receiving the GW_time_info and the group owner information from one or more of the participating APs' broadcasts. This may enable AP4 to discover both the group and the designated coordinator AP1. At S3, AP4 may initiate a Coordination Request directed to the group owner AP1 with an intent to join the MAPC group, based on the coordination capabilities and GW_time_info received. At S4, AP1 may validate the incoming request from AP4 against the group's guard window policy (GW policy), which may be defined based on timing constraints, traffic priorities, or interference considerations.

The validation at S4 may result in one of two possible outcomes: In one outcome as shown by S5, if AP4's request satisfies the GW policy, AP1 may transmit a Coordination Response approving the request. This may trigger S6, wherein AP1 initiates internal (re-) negotiations with existing group members (AP2, AP₃) to integrate AP4. Following successful negotiations, at S7, AP4 becomes a part of the MAPC group.

In S5′, if AP4's request violates the GW policy, AP1 may issue a coordination reject message including a backoff_timer. This timer may be configured to prevent and/or suppress/inhibit AP4 from making repeated join attempts in a short span, thereby minimizing/reducing signalling congestion and interference. Once the backoff timer expires, AP4 may re-attempt the join process.

As shown, steps S5 and S5′ represent two distinct branches of the decision flow, based on the outcome of validation at S4. The inclusion of the backoff_timer ensures that external APs do not overwhelm the group with premature or frequent coordination requests, preserving the stability of ongoing coordinated operations.

FIG. 8B is a signal flow diagram 800B illustrating an example of a new AP initiating communication with one of the participating APs to join an existing multi-AP coordinated (MAPC) group, according to various embodiments.

At S1, a MAPC group comprising AP1, AP2, and AP3 may be already formed, with AP1 acting as the group owner or coordinating AP. In this case, the participating APs may not include the group owner's information in their broadcast messages (e.g., APID or MAC address is omitted), while still broadcasting other group common information such as coordination capabilities.

At S2, a new external AP (AP4) may detect the MAPC group via the received broadcast messages, but since the group owner identity is not included, AP4 may choose to initiate a join procedure via one of the responding APs in this case, AP2. At S3, AP4 may transmit a Coordination Request to AP2 with the intent to join the MAPC group, based on the detected capabilities and coordination features. At S4, AP2 may validate AP4's request against the group's guard window policy (GW policy), which may consider factors such as time synchronization, traffic priority, and interference constraints.

The subsequent steps depend on the result of validation at S4. As shown in FIG. 8B, steps S5 through S8 represent a successful join process routed through a participating AP, while S5′ indicates a rejected path with a delayed retry mechanism. In S5, if AP4 is determined to be eligible to join, AP2 may issue a Coordination Notification to group owner AP1, indicating the intent of AP4 to join the group. At S6, AP2 may then transmit a Coordination Response message back to AP4, indicating acceptance and also redirecting further coordination signalling to the group owner AP1 by providing AP1's identifying information (e.g., APID, MAC address). At S7, AP1 and AP4 may engage in required (re-)negotiation procedures. Finally, at S8, upon successful negotiation, AP4 may be admitted into the MAPC group.

In S5′, if AP4's request does not meet GW policy conditions, AP2 may return a Coordination Reject message including a backoff_timer. This timer may delay further join attempts from AP4, thereby mitigating signalling overhead, reducing potential interference, and preventing/reducing channel congestion. Once the timer expires, AP4 may attempt to re-initiate a coordination request.

The various coordination-related messages exchanged during the process of a new AP attempting to join an existing MAPC group—along with their corresponding contents and functional roles—are summarized in Table 2 below:

TABLE 2

| Message Name | Contents |
|---|---|
| Coordination Request (sent by | {shall at least include a bitmask of coordination features |
| new AP to any participating AP of | interested to join for, e.g. Co-TDMA, Co-SR etc.; |
| the existing MAPC group) | shall at least include the type(s) of data traffic, access |
| | class, priority etc. for which coordination is needed.;} |
| Coordination Notification | {shall at least include requested coordination features |
| (sent by any participating AP to | and new AP's information (APID, MAC address) etc.;} |
| group owner AP) | |
| Coordination Response | {shall at least include ‘allowed’ response per requested |
| (sent by any participating AP to new | coordination feature; |
| AP) | may include an ‘optional field’ which is group owner |
| | AP's information (APID, MAC address) for redirecting |
| | new AP's further signalling towards group owner AP;} |
| Coordination Reject | {shall at least include ‘not allowed’ response per |
| (sent by any participating AP to new | requested coordination feature; |
| AP) | shall at least include a ‘backoff_timer’ field to indicate |
| | new AP to wait for this much time before re-trying to join |
| | this group;} |

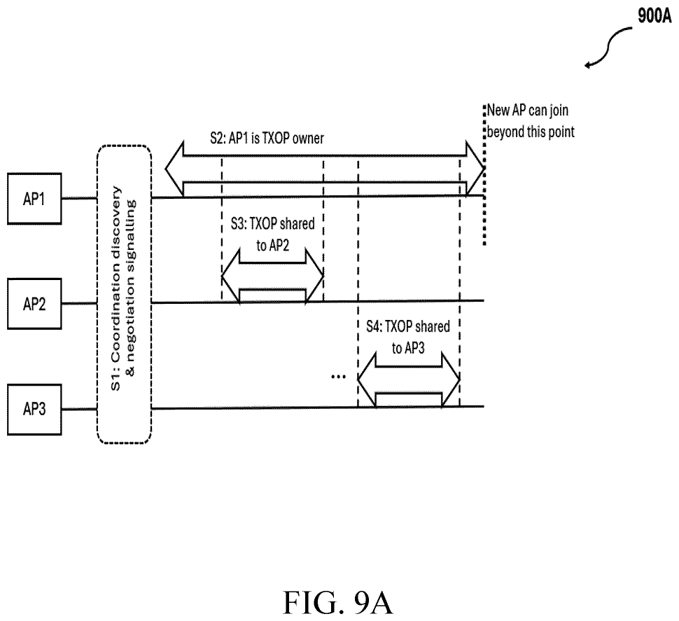

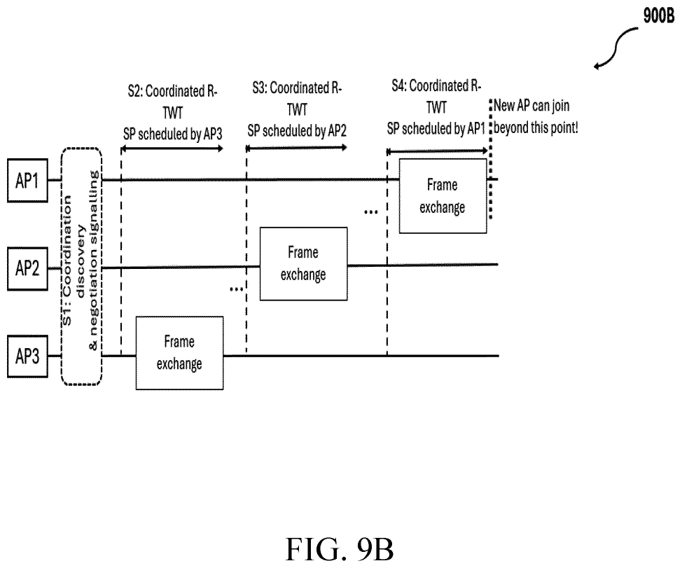

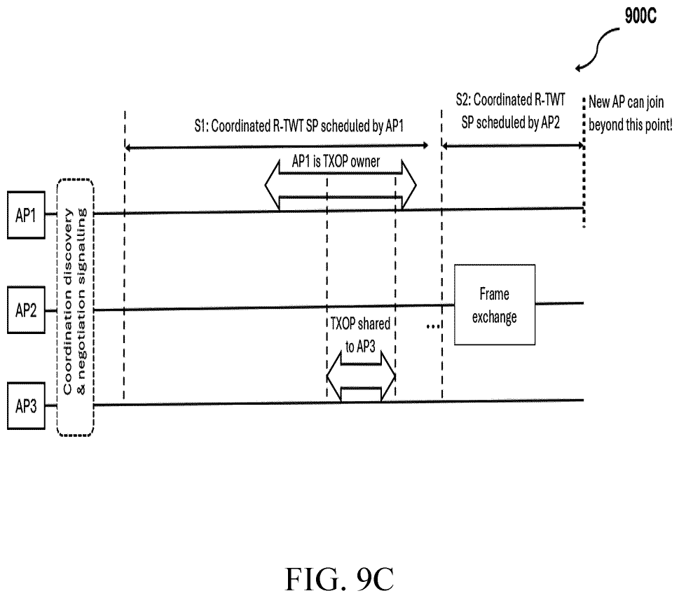

FIG. 9A is a signal flow diagram 900A illustrating an example of managing join requests from an external access point (AP) under a short-term guard window (GW) policy, according to various embodiments.

As shown in FIG. 9A, a coordinated MAPC group may comprise APs including AP1, AP2, and AP3 operating based on short-term coordination schemes, such as transmission opportunity (TXOP)-based coordination, which typically span a duration of a few milliseconds. At S1, the MAPC group may be already formed and operating with active short-term coordinated schedules. Each participating AP may periodically broadcast coordination parameters including a GW_time_info value that indicates the duration for which the current coordination state is expected to be maintained.

At S2, a new external AP may discover the presence of the MAPC group by receiving the broadcasted coordination parameters. The new AP may determine whether and when to initiate a join request based on the received GW_time_info. The external AP may initiate a coordination request to join the group. However, in line with the short-term GW policy, join requests received during an active TXOP-based coordination interval may not be processed immediately to prevent and/or reduce interference or disruption to the ongoing coordination.

In an embodiment, the group may also temporarily defer handling the incoming join request until the ongoing short-term coordinated schedule concludes. The decision to delay handling is based on the current value of GW_time_info, which serves as a threshold indicator for enforcing access control. This approach allows the MAPC group to preserve the integrity of short-duration coordination sessions while providing an opportunity for the external AP to join after the current transmission schedule ends.

At S2, the TXOP is shared to AP2. While the TXOP is shared to AP2, AP2 may broadcast coordination parameters including a GW_time_info value that indicates the duration for which the current coordination state is expected to be maintained. At S3, the TXOP is shared to AP3. While the TXOP is shared to AP3, AP3 may broadcast coordination parameters including a GW_time_info value that indicates the duration for which the current coordination state is expected to be maintained.

FIG. 9B is a signal flow diagram 900B illustrating an example behaviour of a coordinated MAPC group under a long-term guard window (GW) policy, according to various embodiments.

As shown in FIG. 9B, the MAPC group may include AP1, AP2, and AP3, which may operate in a coordinated manner using long-term coordination schemes, such as Coordinated Restricted Target Wake Time (Co-RTWT). These schemes may be associated with Service Period (SP) durations, typically around 16 milliseconds. At S1, the APs (AP1-AP3) may perform coordination discovery and negotiation signalling to exchange capability information and establish agreement on supported coordination features and SP schedules.

Following this negotiation, each AP may begin respective transmission activity as per the agreed schedule. At S2, AP3 may engage in a frame exchange during its allocated SP. At S3, AP2 may perform its transmission or reception within its assigned window, and at S4, AP1 may initiate its own communication activity during its designated SP. Throughout these coordinated operations, a GW_time_info parameter may be broadcasted, indicating a long-term coordination window aligned with the duration of the scheduled SPs. This parameter may serve as an advisory to external APs (not shown) regarding the current coordination context and the expected period of deferral before a join request can be accepted.

In such scenarios, an external AP that wishes to join the MAPC group may need to wait until the completion of the final scheduled SP (e.g., after S4) before initiating a join request, in accordance with the long-term GW policy. This approach may help minimize/reduce disruption to ongoing coordinated activity while maintaining flexibility for later group expansion under policy-compliant conditions.

FIG. 9C is a signal flow diagram 900C illustrating an example behaviour of a coordinated MAPC group where the APs may be operating with a mix of short-term and long-term coordination schemes, according to various embodiments.

As shown in FIG. 9C, the APs—AP1, AP2, and AP3 may form a coordinated group wherein AP1 and AP3 operate under long-term coordination schemes such as Co-RTWT (e.g., service period-based coordination), while AP2 may utilize a short-term scheme such as Co-SR (e.g., TXOP-based coordination).

At S1, the APs may perform coordination discovery and negotiation signalling, exchanging their respective coordination capabilities and scheduling parameters. Upon successful completion, the APs may begin executing their respective communication activities. At S2, AP1 may transmit frames in accordance with its long-term schedule, for instance during a service period. At S3, AP2 may execute its frame exchange under a short-term coordination schedule such as TXOP. Under such a hybrid coordination scenario, a GW_time_info parameter may be broadcasted, reflecting a policy that considers the last scheduled activity among all coordinated APs-whether short-term or long-term. Consequently, an external AP intending to join the MAPC group may be required to defer its join request until after the final scheduled frame exchange (e.g., after S4), thereby minimizing and/or reducing disruption to the ongoing coordinated sessions. This mixed policy framework may provide a fair and synchronized entry mechanism for new APs, while preserving the integrity of ongoing coordinated operations within the MAPC group.

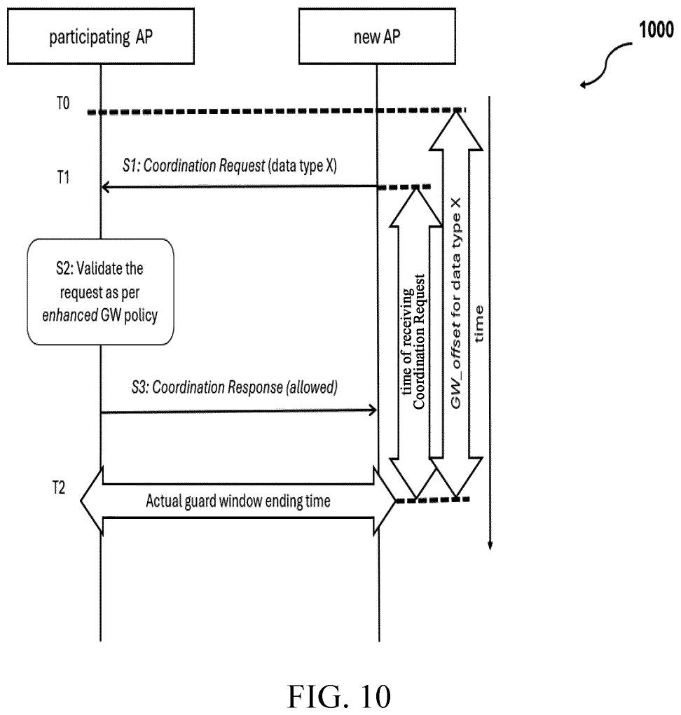

FIG. 10 is a signal flow diagram 1000 illustrating an example enhanced guard window (GW) policy validation based on a dynamic offset mechanism, according to various embodiments.

As shown in FIG. 10, a new AP that intends to join an existing multi-AP coordination (MAPC) group may transmit a Coordination Request to a participating AP. At S1, the Coordination Request may be received by the participating AP from the new AP at a time instance T1. The request may include information such as the data type (e.g., data type X), access category, or traffic priority, which may be used to evaluate whether early joining should be permitted.

The participating AP may evaluate the timing of the request in relation to the ongoing guard window (GW) duration at S2. For example, the participating AP may determine the time remaining until the end of the guard window, computed as T2−T1, and compare it with a predefined GW_offset corresponding to the indicated data type X. The GW_offset may represent a permissible threshold prior to GW expiry, within which early joining of the new AP may be considered.

If the time remaining (T2−T1) is less than or equal to the GW_offset, the request may be deemed to fall within the permissible time margin. In such a case, the participating AP may validate the request as per the enhanced GW policy. Based on this validation and in conjunction with other GW policy conditions as described in prior embodiments, the participating AP may determine that early group joining by the new AP is acceptable. Consequently, the new AP may be permitted to join the MAPC group prior to the natural expiry of the guard window as shown by S3. This dynamic validation process may enable more responsive coordination management, particularly in scenarios involving time-sensitive data types or high-priority traffic.

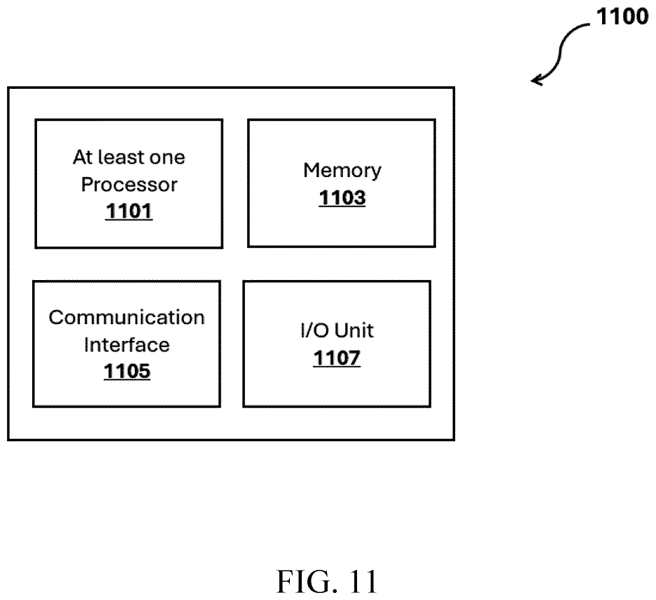

FIG. 11 is a block diagram illustrating an example configuration of an apparatus 1100 for managing a multi-access point (AP) coordinated group, according to various embodiments. In an embodiment, the apparatus 1100 may be similar to the AP1 of FIG. 8A and AP2 of FIG. 8B. In an embodiment, the apparatus 1100 may be designated as a group owner AP.

In an embodiment of the present disclosure, the apparatus 1100 may comprise a memory 1103, at least one processor (e.g., including processing circuitry) 1101, an input/output (I/O) unit (e.g., including various circuitry) 1107, and a communication interface (e.g., including communication circuitry) 1105 communicatively coupled with each other. In an embodiment, the communication interface 1105 may comprise a transmitter, a receiver or a transceiver. The communication interface 1105, which can be implemented by a circuit, may be controlled by the processor 1101. In an embodiment, the 1100 apparatus may be a designated group owner of a centralized multi-AP grouping architecture. In an embodiment of the present disclosure, the apparatus 1100 may be a participating AP of a distributed multi-AP grouping architecture.

It may be noted that, in various embodiments, the apparatus 1100 may include more or fewer components than those depicted herein. The various components of the apparatus 1100 may be implemented using hardware, software, firmware or any combinations thereof. Further, the various components of the apparatus 1100 may be operably coupled with each other. For example, various components of the apparatus 1100 may be capable of communicating with each other using communication channel media (such as buses, interconnects, etc.).

In an embodiment, the at least one processor 1101 may include various processing circuitry and may be embodied as a multi-core processor, a single core processor, or a combination of one or more multi-core processors and one or more single core processors. For example, the at least one processor 1101 may be embodied as one or more of various processing devices, such as a coprocessor, a microprocessor, a controller, a digital signal processor (DSP), a processing circuitry with or without an accompanying DSP, and/or various other processing devices including, a microcontroller unit (MCU), a hardware accelerator, a special-purpose computer chip, or the like.

The at least one processor 1101 may include one or a plurality of processors. One or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). Thus, the processor 1101 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 1101 can include processing circuitry, which can be implemented by a circuit, for example a system on chip (SoC) or an integrated circuit (IC). The processor 1101 may include the combination of one or more processors such as a CPU, GPU, MPU, an application processor (AP), and a communication processor (CP).

In an embodiment, the memory 1103 is capable of storing machine executable instructions, referred to herein as instructions. In an embodiment, the at least one processor 1101 is embodied as an executor of software instructions. As such, the at least one processor 1101 is capable of executing the instructions stored in the memory 1103 to perform one or more operations described herein.

The memory 1103 can be any type of storage accessible to the at least one processor 1101 to perform respective functionalities. For example, the memory 1103 may include one or more volatile or non-volatile memories, or a combination thereof. For example, the memory 1103 may be embodied as semiconductor memories, such as flash memory, mask ROM, PROM (programmable ROM), EPROM (erasable PROM), RAM (random access memory), etc. and the like. The memory 1103 stores instructions that, when executed by at least one processor individually or collectively, cause the apparatus 1100, which can be an AP, to perform the methods and/or the operations described herein. The at least one processor may include the combination of one or more processors such as the processor 1101, the processing circuitry in the communication interface 1105, a CPU, GPU, MPU, an application processor (AP), and a communication processor (CP). The processing circuitry in the communication interface 1105 may be included in the processor 1101.

In an embodiment of the present disclosure, the at least one processor 1101 may be configured to broadcast coordination information comprising a group identifier and guard window time information. To broadcast the coordination information, the at least one processor 1101 may be configured to broadcast guard window time information. The guard window time information may correspond to group-wide guard window time information and one or more feature-specific guard window time information. The at least one processor 1101 may also be configured to broadcast an indicator to specify whether the apparatus 1100 is part of a multi-AP coordinated group and whether the broadcasted guard window time information is applicable to all supported coordination schemes or to selected coordination schemes. Thereafter, the at least one processor 1101 may be configured to update by decrementing the guard window time information in each successive broadcast, after the first broadcast, by a value equal to the time elapsed since the immediately preceding broadcast so as to represent the actual time remaining for guard window to expire at each broadcast.

The coordination information may comprise one or more number of coordination features and a coordination feature bitmask indicating one or more supported coordination schemes. Each bit in the coordination feature bitmask may correspond to a coordination scheme supported by the at least one AP. The guard window time information may comprise a single value applicable to the multi-AP coordinated group when the number of coordination features indicates a null value. The guard window time information may also comprise a plurality of feature-specific values when the number of coordination features indicates a non-null value. Each of the plurality of feature-specific values may be associated with a respective coordination scheme indicated by the coordination feature bitmask.

The coordination information may comprise a coordination flag. The coordination flag may have a first value indicating that the AP is not part of any coordinated group. The coordination flag may also have a second value indicating that the AP is broadcasting group-wide guard window time information, and a third value indicating that the AP is broadcasting feature-specific guard window time information. The at least one processor 1101 may be configured to receive a join request from an external AP requesting to join the multi-AP coordinated group. The at least one processor 1101 may be configured to determine whether the external AP is permitted to join the multi-AP coordinated group based on the guard window time information.

In order to determine whether the external AP is permitted to join the multi-AP coordinated group, the at least one processor 1101 may be configured to retrieve a current value of join request reception time information and compare the current value to a selected threshold to determine whether the guard window time information has expired. Further, to compare the join request reception time information to the threshold, the at least one processor 1101 may be configured to select the threshold in accordance with a guard window policy. the guard window policy comprises one of a short-term coordination policy, a long-term coordination policy, a mixed-term coordination policy and a per-feature coordination policy. The short-term coordination policy may comprise a first threshold defined to delay acceptance of join requests until completion of ongoing coordination. The long-term coordination policy may comprise a second threshold defined to delay acceptance of join requests until completion of ongoing coordination. The mixed-term coordination policy comprises a third threshold defined based on different coordination schemes having different coordination durations. Lastly, the per-feature coordination policy comprises a fourth threshold defined and applied for each coordination scheme, irrespective of total coordination duration.

The guard window time information may comprise a plurality of feature-specific values corresponding to respective coordination schemes. To compare the join request reception time information to the threshold, the at least one processor 1101 may be configured to identify a coordination scheme indicated in the join request received from the external AP. The at least one processor 1101 may also be configured to select, based on the coordination feature bitmask, a feature-specific value corresponding to the identified coordination scheme from the join request and compare the selected feature-specific value to a threshold associated with the identified coordination scheme, in accordance with the guard window policy.

The at least one processor 1101 may be configured to transmit a response to the external AP based on the determination. The response may indicate whether the join request is accepted or rejected. In an embodiment, the at least one processor 1101 may also be configured to forward a coordination notification to a group owner AP. The group owner AP may be designated to manage group-level coordination decisions and transmit, to the external AP, a response to the join request that includes an identifier of the group owner AP and a response code to indicate whether the join request is accepted or rejected.

In case the join request is rejected, the at least one processor 1101 may be configured to transmit a coordination reject message with a response code to indicate rejection and including a backoff timer. The backoff timer may specify a duration for which the external AP is required to wait before reinitiating the join request. The at least one processor 1101 may be configured to prevent and/or suppress/inhibit the external AP from reinitiating the join request until expiration of the backoff timer.

In the case where the join request is accepted, the at least one processor 1101 may be configured to transmit a coordination response message with a response code to indicate acceptance and including an identifier of the group owner AP. The at least one processor 1101 may also be configured to perform a re-negotiation with one or more APs in the multi-AP coordinated group to include the external AP into one or more coordination schemes as requested by the external AP. The at least one processor 1101 may be configured to trigger the re-negotiation based on a determination that the coordination schemes requested for negotiation by the external AP are incompatible with the currently active negotiated agreements for one or more APs in the multi-AP coordinated group. The coordination schemes may comprise one or more of coordinated time division multiple access (Co-TDMA), coordinated restricted target wake time (Co-RTWT), coordinated spatial reuse (Co-SR) and coordinated beam forming (Co-BF).

The at least one processor 1101 may be configured to update the coordination information to include the external AP and transmit, to the external AP, updated coordination information about one or more coordination schemes as requested by the external AP. Moreover, the at least one processor 1101 may be configured to transmit the updated coordination information to the one or more APs in the multi-AP coordinated group.

The at least one processor 1101 may also be configured to periodically broadcast the coordination information in one or more broadcast frames and cease the broadcast of the coordination information when the AP is not part of any multi-AP coordinated group. Moreover, the at least one processor 1101 may be configured to defer handling of join requests from external APs based on the guard window time information until completion of ongoing coordinated transmissions.

The apparatus 1100 of the present disclosure may enable seamless integration of new APs without requiring reformation of the group or disruption of ongoing multi-AP operations. Therefore, the apparatus 1100 of the present disclosure may enhance scalability, ensure robust synchronization, and maintain backward compatibility with legacy APs.

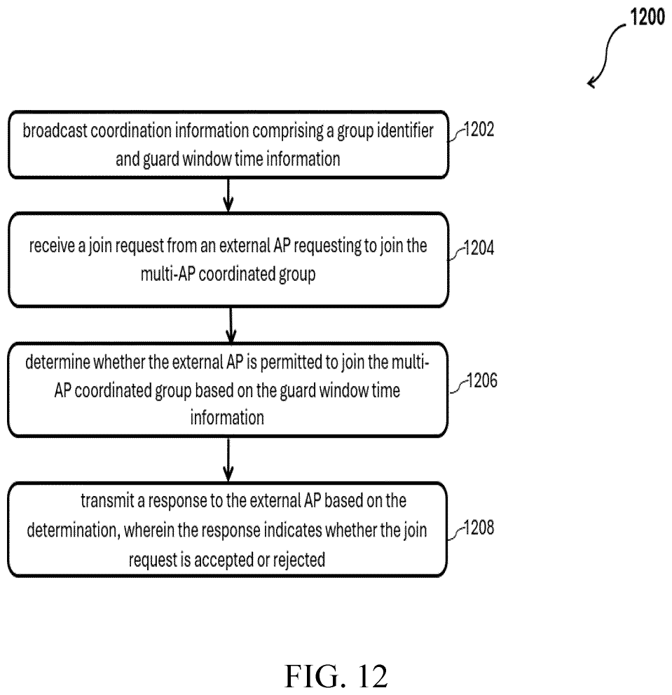

FIG. 12 is a flowchart illustrating an example method for managing a multi-access point (AP) coordinated group, according to various embodiments.

At 1202, the method 1200 discloses broadcasting coordination information comprising a group identifier and guard window time information. Moreover, to broadcast the coordination information, the method 1200 discloses broadcasting guard window time information wherein the guard window time information corresponds to group-wide guard window time information and one or more feature-specific guard window time information. The method 1200 also discloses broadcasting an indicator to specify whether the apparatus is part of a multi-AP coordinated group and whether the broadcasted guard window time information is applicable to all supported coordination schemes or to selected coordination schemes. Thereafter, the method 1200 also discloses updating by decrementing the guard window time information in each successive broadcast, after the first broadcast, by a value equal to the time elapsed since the immediately preceding broadcast so as to represent the actual time remaining for guard window to expire at each broadcast.

The coordination information may comprise one or more number of coordination features and a coordination feature bitmask indicating one or more supported coordination schemes. Each bit in the coordination feature bitmask may correspond to a coordination scheme supported by the at least one AP. Furthermore, the guard window time information may comprise a single value applicable to the multi-AP coordinated group when the number of coordination features indicates a null value. The guard window time information may also comprise a plurality of feature-specific values when the number of coordination features indicates a non-null value. Each of the plurality of feature-specific values may be associated with a respective coordination scheme indicated by the coordination feature bitmask.

The coordination information may comprise a coordination flag. The coordination flag may have a first value indicating that the AP is not part of any coordinated group. The coordination flag may also have a second value indicating that the AP is broadcasting group-wide guard window time information, and a third value indicating that the AP is broadcasting feature-specific guard window time information.

At 1204, the method 1200 discloses receiving a join request from an external AP requesting joining the multi-AP coordinated group. At 1206, the method 1200 discloses determining whether the external AP is permitted to join the multi-AP coordinated group based on the guard window time information.

In order to determine whether the external AP is permitted to join the multi-AP coordinated group, the method 1200 discloses retrieving a current value of join request reception time information and comparing the current value to a selected threshold to determine whether the guard window time information has expired. To compare the join request reception time information to the threshold, the method 1200 discloses selecting the threshold in accordance with a guard window policy. the guard window policy comprises one of a short-term coordination policy, a long-term coordination policy, a mixed-term coordination policy and a per-feature coordination policy. The short-term coordination policy may comprise a first threshold defined to delay acceptance of join requests until completion of ongoing coordination. The long-term coordination policy may comprise a second threshold defined to delay acceptance of join requests until completion of ongoing coordination. The mixed-term coordination policy comprises a third threshold defined based on different coordination schemes having different coordination durations. The per-feature coordination policy comprises a fourth threshold defined and applied for each coordination scheme, irrespective of total coordination duration.

The guard window time information may comprise a plurality of feature-specific values corresponding to respective coordination schemes. Moreover, to compare the join request reception time information to the threshold, the method 1200 discloses identifying a coordination scheme indicated in the join request received from the external AP. The method 1200 also discloses selecting, based on the coordination feature bitmask, a feature-specific value corresponding to the identified coordination scheme from the join request and comparing the selected feature-specific value to a threshold associated with the identified coordination scheme, in accordance with the guard window policy.

Thereafter, at 1208, the method 1200 discloses transmitting a response to the external AP based on the determination. The response may indicate whether the join request is accepted or rejected. In an embodiment, the method 1200 discloses forwarding a coordination notification to a group owner AP. The group owner AP may be designated to manage group-level coordination decisions and transmit, to the external AP, a response to the join request that includes an identifier of the group owner AP and a response code to indicate whether the join request is accepted or rejected.

In case the join request is rejected, the method 1200 discloses transmitting a coordination reject message with a response code to indicate rejection and including a backoff timer. The backoff timer may specify a duration for which the external AP is required to wait before reinitiating the join request. The method 1200 also discloses preventing/inhibiting the external AP from reinitiating the join request until expiration of the backoff timer.

In the case where the join request is accepted, the method 1200 discloses transmitting a coordination response message with a response code to indicate acceptance and including an identifier of the group owner AP. The method 1200 discloses performing a re-negotiation with one or more APs in the multi-AP coordinated group to include the external AP into one or more coordination schemes as requested by the external AP. The method 1200 also discloses triggering the re-negotiation based on a determination that the coordination schemes requested for negotiation by the external AP are incompatible with the currently active negotiated agreements for one or more APs in the multi-AP coordinated group. The coordination schemes may comprise one or more of coordinated time division multiple access (Co-TDMA), coordinated restricted target wake time (Co-RTWT), coordinated spatial reuse (Co-SR) and coordinated beam forming (Co-BF).

The method 1200 discloses updating the coordination information to include the external AP and transmitting, to the external AP, updated coordination information about one or more coordination schemes as requested by the external AP. The method 1200 discloses transmitting the updated coordination information to the one or more APs in the multi-AP coordinated group.

The method 1200 also discloses periodically broadcasting the coordination information in one or more broadcast frames and cease the broadcast of the coordination information when the AP is not part of any multi-AP coordinated group. Moreover, the method 1200 discloses deferring handling of join requests from external APs based on the guard window time information until completion of ongoing coordinated transmissions.

Thus, the method 1200 of the present disclosure may enable seamless integration of new APs without requiring reformation of the group or disruption of ongoing multi-AP operations. Therefore, the method 1200 of the present disclosure may enhance scalability, ensure robust synchronization, and maintain backward compatibility with legacy APs.

The sequence of operations of the method 1200 need not be necessarily executed in the same order as they are presented. Further, one or more operations may be grouped together and performed in the form of a single step, or one operation may have several sub-steps that may be performed in parallel or in sequential manner. Meanwhile, the above-described method 1200 performed by the system 1100 may be performed using an artificial intelligence model.

The disclosed method 1200 with reference to FIG. 12, or one or more operations of the system 1100 explained with reference to FIG. 11 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

One or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the various embodiments described herein. The term “computer-readable medium” may be understood to include tangible items and exclude carrier waves and transient signals, e.g., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

According to an example embodiment, a method for managing a multi-access point (AP) coordinated group by at least one AP is provided. The method comprises broadcasting coordination information comprising a group identifier and guard window time information. The method comprises receiving a join request from an external AP requesting to join the multi-AP coordinated group. The method comprises receiving a join request from an external AP requesting to join the multi-AP coordinated group. The method comprises determining whether the external AP is permitted to join the multi-AP coordinated group based on the guard window time information. The method comprises transmitting a response to the external AP based on the determination, wherein the response indicates whether the join request is accepted or rejected.

According to an example embodiment, the coordination information comprises one or more coordination features and a coordination feature bitmask indicating one or more supported coordination schemes.

According to an example embodiment, each bit in the coordination feature bitmask corresponds to a coordination scheme supported by the at least one AP.

According to an example embodiment, the guard window time information comprises a single value applicable to the multi-AP coordinated group based on the number of coordination features indicating a null value. The guard window time information may comprise a plurality of feature-specific values based on the number of coordination features indicating a non-null value. Each of the plurality of feature-specific values is associated with a respective coordination scheme indicated by the coordination feature bitmask.

According to an example embodiment, the coordination information comprises a coordination flag. The coordination flag includes a first value indicating that the AP is not part of any coordinated group. The coordination flag includes a second value indicating that the AP is broadcasting group-wide guard window time information. The coordination flag includes a third value indicating that the AP is broadcasting feature-specific guard window time information.

According to an example embodiment, the method comprises forwarding a coordination notification to a group owner AP, wherein the group owner AP is designated to manage group-level coordination decisions. The method may further comprise transmitting, to the external AP, a response to the join request including an identifier of the group owner AP and a response code indicating whether the join request is accepted or rejected.

According to an example embodiment, the rejecting of the join request comprises: (1) transmitting a coordination reject message with a response code indicating rejection and including a backoff timer, wherein the backoff timer specifies a duration for which the external AP is required to wait before reinitiating the join request, and/or (2) inhibiting the external AP from reinitiating the join request until expiration of the backoff timer.

According to an example embodiment, the accepting of the join request comprises: (1) transmitting a coordination response message with a response code indicating acceptance and including an identifier of the group owner AP, (2) performing a re-negotiation with one or more APs in the multi-AP coordinated group to include the external AP into one or more coordination schemes as requested by the external AP, (3) updating the coordination information to include the external AP and/or (4) transmitting, to the external AP, updated coordination information about one or more coordination schemes as requested by the external AP.

According to an example embodiment, the re-negotiation is triggered based on a determination that the coordination schemes requested for negotiation by the external AP are incompatible with the currently active negotiated agreements for one or more APs in the multi-AP coordinated group.

According to an example embodiment, the coordination schemes comprise one or more of coordinated time division multiple access (Co-TDMA), coordinated restricted target wake time (Co-RTWT), coordinated spatial reuse (Co-SR) and coordinated beam forming (Co-BF).

According to an example embodiment, the method comprises transmitting the updated coordination information to the one or more APs in the multi-AP coordinated group.

According to an example embodiment, the determining whether the external AP is permitted to join the multi-AP coordinated group comprises: (1) retrieving a current value of join request reception time information, and/or (2) comparing the current value to a selected threshold to determine whether the guard window time information has expired.

According to an example embodiment, the comparing the join request reception time information to the threshold comprises selecting the threshold based on a guard window policy. The guard window policy comprises one of: (1) a short-term coordination policy comprises a first threshold to delay acceptance of join requests until completion of ongoing coordination, (2) a long-term coordination policy comprises a second threshold to delay acceptance of join requests until completion of ongoing coordination, (3) a mixed-term coordination policy comprises a third threshold based on different coordination schemes having different coordination durations, and/or (4) a per-feature coordination policy comprises a fourth threshold applied for each coordination scheme, irrespective of total coordination duration.

According to an example embodiment, the guard window time information comprises a plurality of feature-specific values corresponding to respective coordination schemes. The comparing the join request reception time information to the threshold comprises: (1) identifying a coordination scheme indicated in the join request received from the external AP, (2) selecting, based on the coordination feature bitmask, a feature-specific value corresponding to the identified coordination scheme from the join request, and/or (3) comparing the selected feature-specific value to a threshold associated with the identified coordination scheme, in accordance with the guard window policy.

According to an example embodiment, the broadcasting the coordination information comprises: (1) broadcasting guard window time information wherein the guard window time information corresponds to group-wide guard window time information and one or more feature-specific guard window time information, (2) broadcasting an indicator to specify whether the AP is part of a multi-AP coordinated group and whether the broadcasted guard window time information is applicable to all supported coordination schemes or to selected coordination schemes, and/or (3) updating by decrementing the guard window time information in each successive broadcast, after the first broadcast, by a value equal to the time elapsed since the immediately preceding broadcast to represent the actual time remaining for guard window to expire at each broadcast.

According to an example embodiment, the method comprises: (1) periodically broadcasting the coordination information in one or more broadcast frames, and/or (2) ceasing the broadcast of the coordination information when the at least one AP is not part of any multi-AP coordinated group.

According to an example embodiment, the method comprises deferring, by the at least one AP, handling of join requests from external APs based on the guard window time information until completion of ongoing coordinated transmissions.

According to an example embodiment, the at least one AP is designated as a group owner AP.

According to an example embodiment, an apparatus for managing a multi-AP coordinated group is provided. The apparatus comprises at least one processor including processing circuitry. The apparatus comprises memory storing instructions that, when executed by the at least one processor individually or collectively, cause the AP to: (1) broadcast coordination information comprising a group identifier and guard window time information, (2) receive a join request from an external AP requesting to join the multi-AP coordinated group, (3) determine whether the external AP is permitted to join the multi-AP coordinated group based on the guard window time information, and/or (4) transmit a response to the external AP based on the determination, wherein the response indicates whether the join request is accepted or rejected.

According to an example embodiment, the coordination information comprises one or more coordination features and a coordination feature bitmask indicating one or more supported coordination schemes.

According to an example embodiment, each bit in the coordination feature bitmask corresponds to a coordination scheme supported by the at least one AP.

According to an example embodiment, the guard window time information comprises a single value applicable to the multi-AP coordinated group based on the number of coordination features indicating a null value. The guard window time information may comprise a plurality of feature-specific values based on the number of coordination features indicating a non-null value. Each of the plurality of feature-specific values is associated with a respective coordination scheme indicated by the coordination feature bitmask.

According to an example embodiment, the coordination information comprises a coordination flag. The coordination flag includes a first value indicating that the AP is not part of any coordinated group. The coordination flag includes a second value indicating that the AP is broadcasting group-wide guard window time information. The coordination flag includes a third value indicating that the AP is broadcasting feature-specific guard window time information.

According to an example embodiment, the instructions, when executed by the at least one processor individually or collectively, cause the apparatus to: (1) forward a coordination notification to a group owner AP, wherein the group owner AP is designated to manage group-level coordination decisions, and/or (2) transmit, to the external AP, a response to the join request including an identifier of the group owner AP and a response code indicating whether the join request is accepted or rejected.

According to an example embodiment, to reject the join request, the instructions, when executed by at least one processor individually or collectively, cause the apparatus to: (1) transmit a coordination reject message with a response code indicating rejection and including a backoff timer, wherein the backoff timer specifies a duration for which the external AP is required to wait before reinitiating the join request, and/or (2) inhibit the external AP from reinitiating the join request until expiration of the backoff timer.

According to an example embodiment, to accept the join request, the instructions, when executed by at least one processor individually or collectively, cause the apparatus to: (1) transmit a coordination response message with a response code indicating acceptance and including an identifier of the group owner AP, (2) perform a re-negotiation with one or more APs in the multi-AP coordinated group to include the external AP into one or more coordination schemes as requested by the external AP, (3) update the coordination information to include the external AP and/or (4) transmit, to the external AP, updated coordination information about one or more coordination schemes as requested by the external AP.

According to an example embodiment, the instructions, when executed by at least one processor individually or collectively, cause the apparatus to trigger the re-negotiation based on a determination that the coordination schemes requested for negotiation by the external AP are incompatible with the currently active negotiated agreements for one or more APs in the multi-AP coordinated group.

According to an example embodiment, the coordination schemes comprise one or more of coordinated time division multiple access (Co-TDMA), coordinated restricted target wake time (Co-RTWT), coordinated spatial reuse (Co-SR) and coordinated beam forming (Co-BF).

According to an example embodiment, wherein the instructions, when executed by at least one processor individually or collectively, cause the apparatus to transmit the updated coordination information to the one or more APs in the multi-AP coordinated group.

According to an example embodiment, to determine whether the external AP is permitted to join the multi-AP coordinated group, the instructions, when executed by at least one processor individually or collectively, cause the apparatus to: (1) retrieve a current value of join request reception time information, and/or (2) compare the current value to a selected threshold to determine whether the guard window time information has expired.

According to an example embodiment, to compare the join request reception time information to the threshold, the instructions, when executed by at least one processor individually or collectively, cause the apparatus to select the threshold based on a guard window policy. The guard window policy comprises one of: (1) a short-term coordination policy comprises a first threshold to delay acceptance of join requests until completion of ongoing coordination, (2) a long-term coordination policy comprises a second threshold to delay acceptance of join requests until completion of ongoing coordination, (3) a mixed-term coordination policy comprises a third threshold based on different coordination schemes having different coordination durations, and/or (4) a per-feature coordination policy comprises a fourth threshold applied for each coordination scheme, irrespective of total coordination duration.

According to an example embodiment, the guard window time information comprises a plurality of feature-specific values corresponding to respective coordination schemes. To compare the join request reception time information to the threshold, the instructions, when executed by at least one processor individually or collectively, cause the apparatus to: (1) identify a coordination scheme indicated in the join request received from the external AP, (2) select, based on the coordination feature bitmask, a feature-specific value corresponding to the identified coordination scheme from the join request, and/or (3) compare the selected feature-specific value to a threshold associated with the identified coordination scheme, in accordance with the guard window policy.

According to an example embodiment, to broadcast the coordination information, the instructions, when executed by at least one processor individually or collectively, cause the apparatus to: (1) broadcast guard window time information wherein the guard window time information corresponds to group-wide guard window time information and one or more feature-specific guard window time information, (2) broadcast an indicator to specify whether the AP is part of a multi-AP coordinated group and whether the broadcasted guard window time information is applicable to all supported coordination schemes or to selected coordination schemes, and/or (3) update by decrementing the guard window time information in each successive broadcast, after the first broadcast, by a value equal to the time elapsed since the immediately preceding broadcast to represent the actual time remaining for guard window to expire at each broadcast.

According to an example embodiment, the instructions, when executed by at least one processor individually or collectively, cause the apparatus to: (1) periodically broadcast the coordination information in one or more broadcast frames, and/or (2) cease the broadcast of the coordination information when the at least one AP is not part of any multi-AP coordinated group.

According to an example embodiment, the instructions, when executed by at least one processor individually or collectively, cause the apparatus to defer, by the at least one AP, handling of join requests from external APs based on the guard window time information until completion of ongoing coordinated transmissions.

According to an example embodiment, the at least one AP is designated as a group owner AP.

According to an example embodiment, a non-transitory computer-readable storage medium is provided. The methods disclosed herein can be performed by one or more computer programs stored on the non-transitory computer-readable storage.

According to an example embodiment, a non-statutory computer-readable storage medium storing one or more computer programs comprising instructions to perform a method for managing a multi-access point (AP) coordinated group by at least one AP is provided. The method comprises broadcasting coordination information comprising a group identifier and guard window time information. The method comprises receiving a join request from an external AP requesting to join the multi-AP coordinated group. The method comprises receiving a join request from an external AP requesting to join the multi-AP coordinated group. The method comprises determining whether the external AP is permitted to join the multi-AP coordinated group based on the guard window time information. The method comprises transmitting a response to the external AP based on the determination, wherein the response indicates whether the join request is accepted or rejected.

It will be understood by those within the art that, in general, terms used herein, and are generally intended as “open” terms (e.g., the term “including” may be interpreted as “including but not limited to,” the term “having” may be interpreted as “having at least,” the term “includes” may be interpreted as “includes but is not limited to,” etc.). For example, as an aid to understanding, the detail description may contain usage of the introductory phrases “at least one” and “one or more” to introduce recitations. However, the use of such phrases may not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” may typically be interpreted to refer to “at least one” or “one or more”) are included in the recitations; the same holds true for the use of definite articles used to introduce such recitations. In addition, even if a specific part of the introduced description recitation is explicitly recited, those skilled in the art will recognize that such recitation may typically be interpreted to refer to at least the recited number (e.g., the bare recitation of “two recitations,” without other modifiers, typically refers to at least two recitations or two or more recitations). The phrase “one or more of,” when used with a list of items, means that different combinations of one or more of the listed items may be used, and only one item in the list may be needed. For example, “one or more of: A, B, of C” includes any of the following combinations: A, B, C, A and B, A and C, B and C, and A and B and C.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following detailed description. It will also be understood that any of the embodiment(s) described herein may be used in conjunction with any other embodiment(s) described herein.

What is claimed is:

1. An apparatus for managing a multi-AP coordinated group, the apparatus comprising:
at least one processor including processing circuitry; and
memory storing instructions that, when executed by the at least one processor individually or collectively, cause the AP to:
broadcast coordination information comprising a group identifier and guard window time information;
receive a join request from an external AP requesting to join the multi-AP coordinated group;
determine whether the external AP is permitted to join the multi-AP coordinated group based on the guard window time information; and
transmit a response to the external AP based on the determination, wherein the response indicates whether the join request is accepted or rejected.

2. The apparatus of claim 1, wherein the coordination information further comprises:
one or more coordination features and a coordination feature bitmask indicating one or more supported coordination schemes.

3. The apparatus of claim 2, wherein each bit in the coordination feature bitmask corresponds to a coordination scheme supported by the apparatus.

4. The apparatus of claim 2, wherein the guard window time information comprises:
a single value applicable to the multi-AP coordinated group based on the number of coordination features indicating a null value, and
a plurality of feature-specific values based on the number of coordination features indicating a non-null value, wherein each of the plurality of feature-specific values is associated with a respective coordination scheme indicated by the coordination feature bitmask.

5. The apparatus of claim 1, wherein the coordination information further comprises a coordination flag, the coordination flag including:
a first value indicating that the apparatus is not part of any coordinated group,
a second value indicating that the apparatus is broadcasting group-wide guard window time information, and
a third value indicating that the apparatus is broadcasting feature-specific guard window time information.

6. The apparatus of claim 1, wherein the instructions, when executed by the at least one processor individually or collectively, cause the apparatus to:
forward a coordination notification to a group owner AP, wherein the group owner AP is designated to manage group-level coordination decisions; and
transmit, to the external AP, a response to the join request including an identifier of the group owner AP and a response code indicating whether the join request is accepted or rejected.

7. The apparatus of claim 1, wherein to reject the join request, the instructions, when executed by at least one processor individually or collectively, cause the apparatus to:
transmit a coordination reject message with a response code indicating rejection and including a backoff timer, wherein the backoff timer specifies a duration for which the external AP is required to wait before reinitiating the join request; and
inhibit the external AP from reinitiating the join request until expiration of the backoff timer.

8. The apparatus of claim 1, wherein to accept the join request, the instructions, when executed by at least one processor individually or collectively, cause the apparatus to:
transmit a coordination response message with a response code indicating acceptance and including an identifier of the group owner AP;
perform a re-negotiation with one or more APs in the multi-AP coordinated group to include the external AP into one or more coordination schemes as requested by the external AP;
update the coordination information to include the external AP; and
transmit, to the external AP, an updated coordination information about one or more coordination schemes as requested by the external AP.

9. The apparatus of claim 8, wherein the instructions, when executed by at least one processor individually or collectively, cause the apparatus to:
trigger the re-negotiation based on a determination that the coordination schemes requested for negotiation by the external AP are incompatible with the currently active negotiated agreements for one or more APs in the multi-AP coordinated group.

10. The apparatus of claim 9, wherein the coordination schemes comprise one or more of coordinated time division multiple access (Co-TDMA), coordinated restricted target wake time (Co-RTWT), coordinated spatial reuse (Co-SR) and coordinated beam forming (Co-BF).

11. The apparatus of claim 9, wherein the instructions, when executed by at least one processor individually or collectively, cause the apparatus to:
transmit the updated coordination information to the one or more APs in the multi-AP coordinated group.

12. The apparatus of claim 1, wherein to determine whether the external AP is permitted to join the multi-AP coordinated group, the instructions, when executed by at least one processor individually or collectively, cause the apparatus to:
retrieve a current value of join request reception time information; and
compare the current value to a selected threshold to determine whether the guard window time information has expired.

13. The apparatus of claim 12, wherein to compare the join request reception time information to the threshold, the instructions, when executed by at least one processor individually or collectively, cause the apparatus to select the threshold according to a guard window policy, wherein the guard window policy comprises one of:
a short-term coordination policy comprises a first threshold to delay acceptance of join requests until completion of ongoing coordination;
a long-term coordination policy comprises a second threshold to delay acceptance of join requests until completion of ongoing coordination;
a mixed-term coordination policy comprises a third threshold based on different coordination schemes having different coordination durations; and
a per-feature coordination policy comprises a fourth threshold applied for each coordination scheme, irrespective of coordination duration.

14. The apparatus of claim 12, wherein the guard window time information comprises a plurality of feature-specific values corresponding to respective coordination schemes, and wherein to compare the join request reception time information to the threshold, the instructions, when executed by at least one processor individually or collectively, cause the apparatus to:
identify a coordination scheme indicated in the join request received from the external AP;
select, based on the coordination feature bitmask, a feature-specific value corresponding to the identified coordination scheme from the join request; and
compare the selected feature-specific value to a threshold associated with the identified coordination scheme, according to the guard window policy.

15. The apparatus of claim 1, wherein to broadcast the coordination information, the instructions, when executed by at least one processor individually or collectively, cause the apparatus to:
broadcast guard window time information wherein the guard window time information corresponds to group-wide guard window time information and one or more feature-specific guard window time information,
broadcast an indicator to specify whether the apparatus is part of a multi-AP coordinated group and whether the broadcasted guard window time information is applicable to all supported coordination schemes or to selected coordination schemes, and
update by decrementing the guard window time information in each successive broadcast, after the first broadcast, by a value equal to the time elapsed since the immediately preceding broadcast so as to represent the actual time remaining for guard window to expire at each broadcast.

16. The apparatus of claim 1, wherein the instructions, when executed by at least one processor individually or collectively, cause the apparatus to:
periodically broadcast the coordination information in one or more broadcast frames; and
cease the broadcast of the coordination information based on the AP not being part of any multi-AP coordinated group.

17. The apparatus of claim 1, wherein the instructions, when executed by at least one processor individually or collectively, cause the apparatus to:
defer handling of join requests from external APs based on the guard window time information until completion of ongoing coordinated transmissions.

18. The apparatus of claim 1, wherein the apparatus is designated as a group owner AP.

19. A method for managing a multi-access point (AP) coordinated group by at least one AP, the method comprising:
broadcasting coordination information comprising a group identifier and guard window time information;
receiving a join request from an external AP requesting to join the multi-AP coordinated group;
determining whether the external AP is permitted to join the multi-AP coordinated group based on the guard window time information; and
transmitting a response to the external AP based on the determination, wherein the response indicates whether the join request is accepted or rejected.

20. The method of claim 19, wherein the coordination information further comprises:
one or more coordination features and a coordination feature bitmask indicating one or more supported coordination schemes.
